(19) United States
(12) Patent Application Publication
(10) Pub. No.: US 2016/0011735 A1
(43) Pub. Date: Jan. 14, 2016

(54) DYNAMIC ACTION SELECTION FOR TOUCH SCREENS

(71) Applicant: Yahoo! Inc., Sunnyvale, CA (US)

(72) Inventors: Chris Stoner, Sunnyvale, CA (US); Sam Julian, Cupertino, CA (US)

(21) Appl. No.: 14/327,573

(22) Filed: Jul. 10, 2014

(51) Int. Cl. G06F 3/0488; G06F 3/0481; G06F 3/0482; G06F 3/0484; G06F 3/0486

(52) U.S. Cl. CPC G06F 3/0488; G06F 3/04842; G06F 3/0486; G06F 3/0482; G06F 3/04817

(57) ABSTRACT

A method for determining an action to be performed for a content item includes the following operations: presenting a content item on a touch screen; receiving input via the touch screen indicating selection of the content item, wherein the selection of the content item produces a reduced version of the content item; in response to receiving the first input, displaying a plurality of options on the touch screen, each of the options identifying an action to be taken for the content item; detecting a dragging action on the reduced version of the selected content item that places the reduced version of the content item proximate to one of the plurality of options to indicate selection of the one of the plurality of options; performing the action identified by the selected one of the options for the content item.

### BACKGROUND

1. Field of the Invention

The present invention relates to methods and systems for dynamic action selection for touch screens.

2. Description of the Related Art

The popularity of touchscreen devices has grown tremendously in recent years. Media applications typically employ button-based interfaces to take certain actions or provide for interaction with displayed content. However, such interface paradigms become unwieldy when more than a few options are presented, resulting in a poor user experience that may require the user to hunt through extended lists or menus to find the option that he/she wishes to access. Furthermore, existing interface paradigms are not amenable to dynamic reconfiguration, as rearrangement of options may create additional confusion for the user.

It is in this context that embodiments of the invention arise.

### SUMMARY

Broadly speaking, embodiments of the present invention provide methods and systems for dynamic action selection for touch screens. Several inventive embodiments of the present invention are described below.

A modal flow allows the presentation of contextual actions related to an object selected through a tap & hold mechanic rather than a traditional button pressing sequence. The display can be a lightweight translucent overlay above the previous view, and a UI mechanism to accommodate the selection of options beyond what is immediately visible, such as a scroll wheel or list. The selected object can then be maneuvered with a drag & release over the desired action.

Adoption of the presently described interaction mechanic will allow interfaces to have fewer objects cluttering the screen. A potentially limitless number of options could be accessed through the initially hidden interface.

Unique contextual information about user behavior allows for the most likely actions to be suggested and prioritized, which minimizes the potential for user pain points and confusion. Because the actions become tied to gestural motions, these actions will become easy and natural with repeated use.

An object within a digital interface can have any number of contextual actions (For example: share, save, call, message, copy, paste). The object is ‘selected’ through a tap and hold gesture. Upon selection the object appears to pop out of its resting point and follow along with the user's held-down finger, implying user control. At this point, the object may also transform into a more manageable shape (e.g. shrinking to roughly the size of the finger-press) for the user to manipulate, while still retaining enough of its original appearance so as to be understood as the same object.

The location from which the object was removed can still be visible behind a translucent overlay in a layer below, with some cosmetic elements changed so as to imply distance from the selected object. For example, the view below might be shadowed, blurred, shrunk or otherwise distorted. If the user were to release their finger, the object would transform back into place, allowing for easy dismissal of the interface. This keeps the user in the same conceptual context, rather than altering their environment immediately. It makes the action more ‘lightweight’ than it would be otherwise, and allows for the user to experiment and explore the interface without committing any changes.

Simultaneously with the object's transformation, a display of contextual actions would appear above the previous view. This display could take on any number of appearances. The selectable actions can be visually represented by icons and/or labels. The icons can respond visually to the user's movements, so as to indicate awareness of the selected object's location. This highlights the action to be selected (e.g. the potential drop target). If the user releases their finger within a certain distance of a particular action, that action would then be initiated. These areas could be considered ‘drop-zones’.

Certain zones can dynamically alter the display so as to show additional options. For example, dragging the object to the end of a list can cause the list to scroll, and additional actions from the list will be revealed and possibly selected.

The display can be fluid and dynamic so that the actions could reasonably be displayed in various orders. Generally, the actions the user is determined to be most likely to take at this particular time can be placed in the most accessible and visible parts of the display. This allows the service provider to anticipate and better serve the user. Consequently, the user has easy access to a custom list of the actions for which they have the most use. For example, if a user sharing information prefers to send information to select individuals, this interface allows for those individuals to be surfaced at the top-level of the share sequence. In competing products, to send information to a custom list it would take 2-3 levels of selection to arrive at a similar action.

Upon selection, the user is brought through whatever flow is necessary to complete the selected action. For example if the user elected to share the object to a social networking site, they would be brought to the proper interface to complete that sharing action. After completion of the action, the user would be returned to their prior location within the program to which the actionable object belonged to.

Given that the aforementioned mechanic may be difficult for new users to use at first, an alternate navigation setup is contemplated, wherein initiation could be triggered through a button rather than tap and hold. In this scenario, dismissal of the interface would not trigger upon release of the user's finger. To dismiss the interface, the user could tap an ‘empty’ area apart from the object or the available drop zones. Drop zones could be selected and navigated independently of the object. Instead of dragging the object over to the action, the user could tap the desired action, and scroll through the selections. The selected object could still be dragged and released over an action, so as to allow the user maximum flexibility and potential to learn the new action.

This design interface allows the user to browse and select a higher number of contextual actions than are available on any existing interfaces. The overlay display and thumbnailed view of the object being shared keeps the user within the context of their browsing experience, allowing them to access and dismiss the modal without disruption. The fluidity of the design also allows the service provider the flexibility to prioritize the display of relevant information without obstructing access to the user's full range of options.

In one embodiment, a method for determining an action to be performed for a content item is provided, comprising: presenting a content item on a touch screen; receiving input via the touch screen indicating selection of the content item, wherein the selection of the content item produces a reduced version of the content item; in response to receiving the first input, displaying a plurality of options on the touch screen, each of the options identifying an action to be taken for the content item; detecting a dragging action on the reduced version of the selected content item that places the reduced version of the content item proximate to one of the plurality of options to indicate selection of the one of the plurality of options; performing the action identified by the selected one of the options for the content item; the method being executed by a processor.

In one embodiment, each option is rendered as a graphical icon or textual identifier on the touch screen.

In one embodiment, the placement of the reduced version of the content item proximate to the one of the plurality of options is defined by placement of the reduced version adjacent to, partially overlapping, or fully overlapping, the one of the plurality of options.

In one embodiment, the plurality of options that are displayed define a portion of a cyclic arrangement of options.

In one embodiment, the plurality of options include one or more of a social network, an electronic communication, a contact.

In one embodiment, producing the reduced version of the content item includes identifying an image in the content item, and prioritizing the image in the reduced version of the content item.

In another embodiment, a method for determining an action to be performed for a content item is provided, comprising: presenting a content item on a touch screen; receiving a first input via the touch screen, the first input indicating selection of the content item; in response to receiving the first input, rendering a portion of a cyclic arrangement of options on the touch screen, each of the options identifying an action to be taken for the content item; receiving a second input via the touch screen, the second input indicating a selected option of the cyclic arrangement; in response to receiving the second input, performing the action identified by the selected one of the options for the content item; the method being executed by a processor.

In one embodiment, the first input is defined by a tap-and-hold gesture received via the touch screen and applied to the content item, the tap-and-hold gesture indicating selection of the content item and providing for control over movement of the content item as it is rendered on the touch screen; wherein the second input is defined by a drag-and-release gesture received via the touch screen and applied to the content item, the drag-and-release gesture providing for movement of the content item to the selected option and placement thereon.

In one embodiment, the cyclic arrangement identifies options for sharing the content item to one or more of a social network, a specific user.

In one embodiment, selection of the option to share to a social network provides access to an interface for generating a post to the social network, the post being predefined to include a reference to the content item.

In one embodiment, the cyclic arrangement is configured for rotation in response to a third input; wherein rotation exposes an additional option, and hides an existing option, in the rendered portion of the cyclic arrangement.

In one embodiment, the method further comprises: determining a rotational position of the cyclic arrangement of options, the rotational position defining the portion of the cyclic arrangement that is rendered, wherein the rotational position is determined based on one or more of an attribute of the content item, a profile of a user of the touch screen, a communications history associated to the user.

In another embodiment, a non-transitory computer-readable medium having program instructions defined thereon for determining an action to be performed for a content item is provided, the program instructions including: program instructions for presenting a content item on a touch screen; program instructions for receiving input via the touch screen indicating selection of the content item, wherein the selection of the content item produces a reduced version of the content item; program instructions for, in response to receiving the first input, displaying a plurality of options on the touch screen, each of the options identifying an action to be taken for the content item; program instructions for detecting a dragging action on the reduced version of the selected content item that places the reduced version of the content item proximate to one of the plurality of options to indicate selection of the one of the plurality of options; program instructions for performing the action identified by the selected one of the options for the content item.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIGS. 1A, 1B, 1C, 1D, 1E, and 1F, illustrate a sequence of interactions with an interface configured to define a selection of an action to be taken for a content object, in accordance with an embodiment of the invention.

FIG. 1G illustrates an options wheel 130 as it is displayed on a touchscreen display 100, in accordance with an embodiment of the invention.

FIG. 2 illustrates an embodiment wherein in response to selection of the object 200 by the user, two options exposed from top and bottom portions of the display, in accordance with an embodiment of the invention.

FIG. 3 illustrates an interface wherein options are arranged surrounding a selected object 300, in accordance with an embodiment of the invention.

FIG. 4 illustrates an interface wherein options are arranged along a side of the display, in accordance with an embodiment of the invention.

FIG. 5 illustrates an interface having two options wheels displayed at top and bottom portions of the display, in accordance with an embodiment of the invention.

FIG. 6 illustrates an interface wherein a selected object is surrounded by a plurality of options, in accordance with an embodiment of the invention.

FIG. 7 illustrates an interface wherein two horizontal scrollable lists are rendered along top and bottom portions of the display, in accordance with an embodiment of the invention.

FIGS. 8A, 8B, and 8C illustrate a transformation sequence for an object that has been selected, in accordance with an embodiment of the invention.

FIGS. 9A, 9B, and 9C illustrate a transformation sequence for a selected object 900, in accordance with an embodiment of the invention.

FIGS. 10A, 10B, and 10C illustrate a transformation sequence for a selected object 1000, in accordance with an embodiment of the invention.

FIGS. 11A, 11B, and 11C illustrate a transformation sequence for a selected object 1100, in accordance with an embodiment of the invention.

FIG. 12 illustrates a system for presentation and sharing of content, in accordance with an embodiment of the invention.

FIG. 13 illustrates an embodiment of a general computer system, in accordance with an embodiment of the invention.

### DETAILED DESCRIPTION

The following embodiments describe systems and methods for dynamic action selection for touch screens. It will be obvious, however, to one skilled in the art, that the present invention may be practiced without some or all of these specific details. In other instances, well known process operations have not been described in detail in order not to unnecessarily obscure the present invention.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning.

Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Embodiments described herein provide for the presentation of contextual actions related to an object selected through a tap & hold mechanic rather than a traditional button pressing sequence.

The display of the contextual actions can be defined by a lightweight translucent overlay above the previous view, providing a UI mechanism to accommodate the selection of options beyond what is immediately visible, such as a scroll wheel or list. A selected object can be maneuvered with a drag & release over the desired action.

The interaction mechanic described herein allows for an interface to have fewer objects cluttering the screen, while still providing access to a large number of options in an intuitive manner. The interface can be initially hidden, but easily accessed on-demand, for example, through a touch-and-hold interaction with an object.

Unique contextual information about user behavior allows for the most likely actions to be suggested and prioritized, which minimizes the potential for user pain points and confusion. Because the actions become tied to gestural motions, these actions will become easy and natural with repeated use.

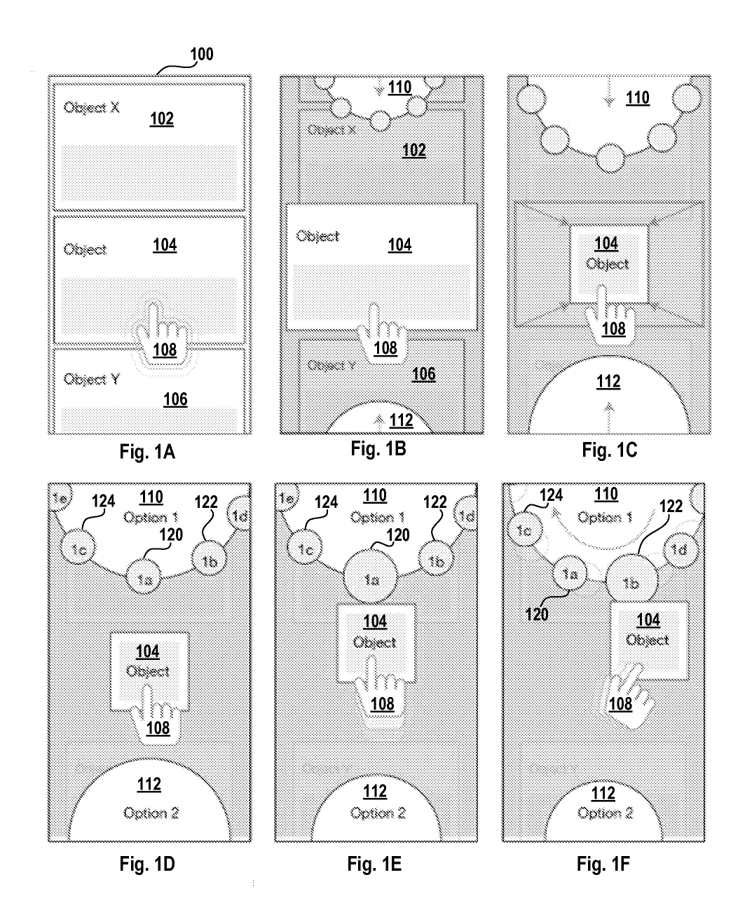

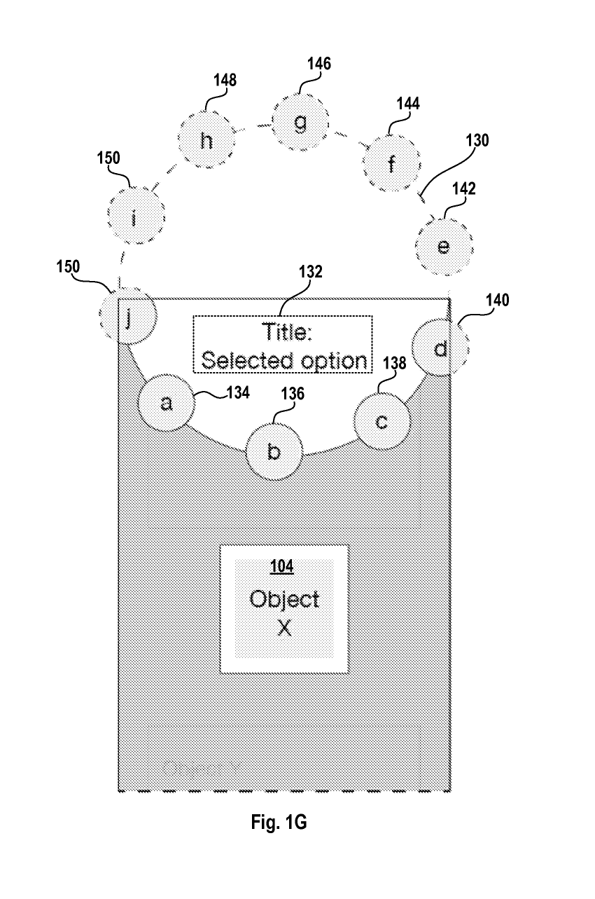

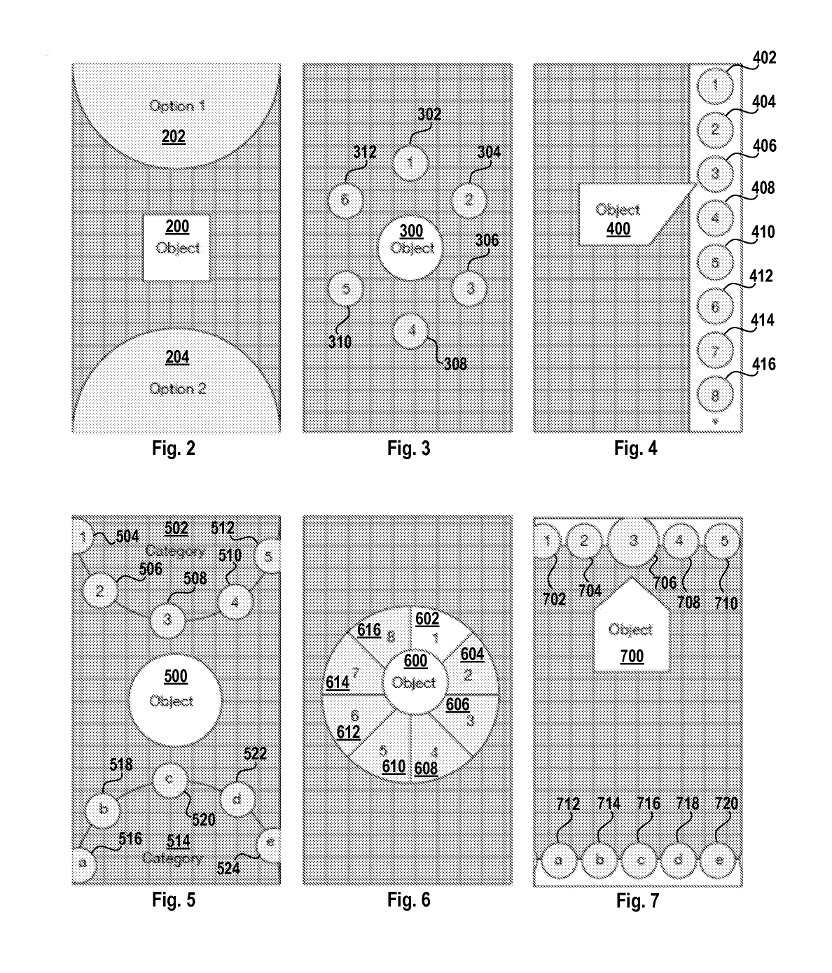

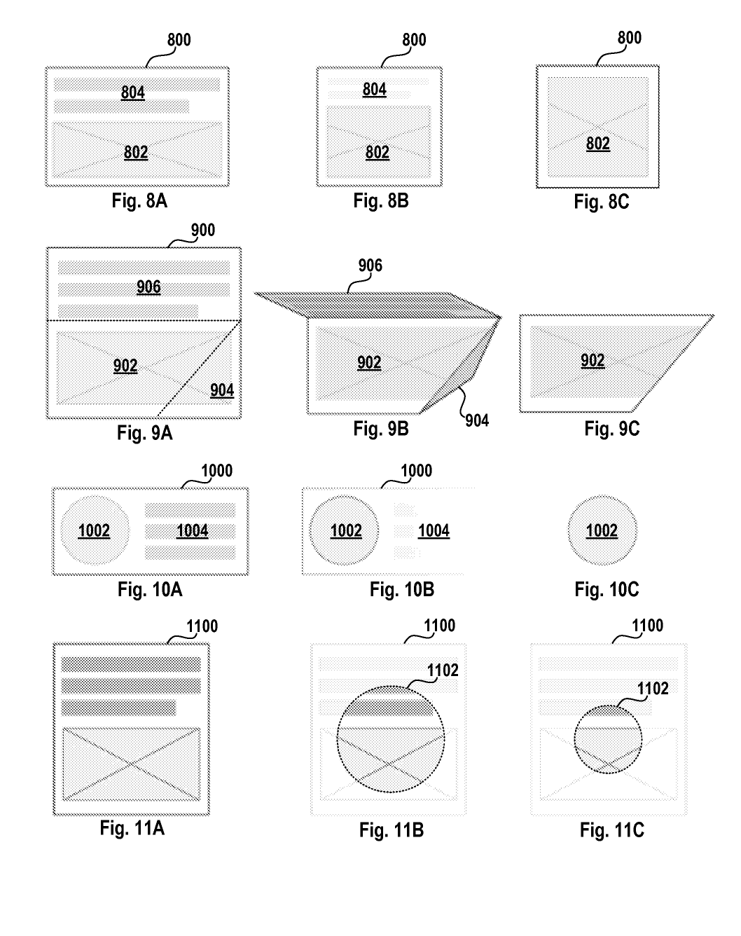

FIGS. 1A, 1B, 1C, 1D, 1E, and 1F, illustrate a sequence of interactions with an interface configured to define a selection of an action to be taken for a content object, in accordance with an embodiment of the invention.

FIG. 1A illustrates a stream of content objects rendered on a touchscreen 100, in accordance with an embodiment of the invention. In the illustrated embodiment, objects 102, 104, and 106 are currently displayed on the touchscreen 100. The objects are presented as a scrollable stream, such that a user may scroll the stream up or down by swiping up or down on the touchscreen 100.

It will be appreciated that the objects can be defined by any kind of content that may be rendered to the touchscreen 100, including, without limitation, articles, pictures, videos, audio, social network activity/posts, advertisements, electronic messages, e-mail, reminders, alerts, notifications, application updates, game updates, etc. An object may be a preview or representation of a content item that when selected, provides access to the full content item. One example is an article preview, which might include a headline, representative image, summary, descriptive phrase/sentence, or other information that previews the full article. An image preview might be defined by a miniaturized version or a selected portion of a full image, and might further include descriptive text or a title. A video preview might be defined to include a selected image from the full video, as well as a title or descriptive text. These examples of previews or representations of full content items are provided by way of example only, and not by way of limitation. Other examples of previews or representations pertaining to various content items will be apparent to those skilled in the art, and may be presented in a stream of content as herein described. Selection of a preview or representation of a content item by a given user will typically result in navigation to or access to the full content item. In some implementations, this is accomplished by tapping or double tapping on a given preview.

For purposes of the present disclosure, content items and their previews or representations shall be considered interchangeably. That is, presentation of a content item may be defined by presentation of the content item itself, or presentation of a preview or representation thereof. In some embodiments, the stream of content can be defined by content of a particular type, kind, genre, etc. Examples include a social network feed, a news feed, a chat log, a blog, etc. In other embodiments, the stream of content may be configured to include content of various types.

With continued reference to FIG. 1A, the object 104 is selected by the user via a tap and hold (a.k.a. touch and hold, or long press) interaction that is received by the touchscreen 100. This is represented by the hand 108, which is shown for illustrative purposes to demonstrate the interaction of the user's finger on the touchscreen 100.

At FIG. 1B, the selected object 104 appears to pop out of its location within the stream of objects. In the illustrated embodiment, the object 104 is movable under the control of the user apart from the content stream, and the presentation of the content stream is altered so as to diminish its prominence to the user, thereby highlighting the selected object 104. More specifically, the content stream (including objects 102 and 106) is shrunk, providing an illusion of the selected object 104 rising out of the content stream. Furthermore, the content stream may be faded, desaturated, blurred, reduced in brightness, reduced in luminance, reduced in contrast, and/or otherwise altered so as to be deemphasized and/or moved into the background.

Simultaneous with the adjustments to the object 104 and the remainder of the content stream, an options wheel 110 opens from the top of the display, while a separate option 112 opens from the bottom of the display. The options wheel 110 is initially displayed at a reduced size, and appears to move down from the top of the touchscreen display 100. The separate option 112 is also initially displayed at a reduced size, and appears to move up from the bottom of the touchscreen display 100.

As shown at FIG. 1C, the options wheel 110 continues to move down from the top of the touchscreen display, and also grows in size. Simultaneously, the separate option 112 continues to move up from the bottom of the touchscreen display, and also grows in size. Additionally, the object 104 is resized to a smaller form (a reduced version), to provide the user with a more intuitive sense of control over the movement of the object 104. The resizing of the object 104 may include reducing the dimensions of the object 104 in a proportional or disproportional manner. In the illustrated embodiment, the object 104 is shrunk from its original rectangular form down to a substantially square form as shown at FIG. 1C.

At FIG. 1D, the movement of the options wheel 110 and the separate option 112 on to the display is complete. As shown, the object 104 is presently controlled by the user and held in a substantially central location within the interface. If the user were to release their finger at this point, then the previously described animations would reverse themselves, and the object 104 would appear to return to its place within the content stream as originally shown with reference to FIG. 1A.

With continued reference to FIG. 1D, the options wheel 110 is shown to include various selectable options 120, 122, and 124. The options can be pictorially represented by images, text, logos, or any other visual indication of the options.

At FIG. 1E, the user has moved object 104 towards the option 120, resulting in the option 120 being dynamically expanded to indicate that the option 120 will be selected if the user releases the object 104 at this point. That is, an action that is indicated by the option 120 will be carried out for the object 104. In some embodiments, a displayed option may have an activation zone defined around it, such that when the object 104 is maneuvered into the activation zone, then the option will be activated to indicate that the option may be selected if the object 104 is released.

Though in some implementations, a given option may be expanded to indicate that it is currently activated, it will be appreciated that the option can be dynamically altered in other ways to indicate that is currently activated. For example, an option can be displayed as flashing, highlighted, animated, radiating, or otherwise presented in a manner differing from those of the other options so as to indicate that it is currently activated, and will be selected if the user releases the object at that point in time.

With reference to FIG. 1F, the object 104 has been dragged to the right by the user, thereby resulting in a counterclockwise rotation of the options wheel 110. Dragging the object 104 to the left would similarly result in clockwise rotation of the options wheel 110. With continued reference to FIG. 1F, option 122 is now the closest option to the object 104, and has been dynamically resized to indicate that it is currently activated, and will be selected if the object 104 is released by the user.

FIG. 1G illustrates an options wheel 130 as it is displayed on a touchscreen display 100, in accordance with an embodiment of the invention. The configuration of the options wheel 130 implies off-screen options which can be rotated into view. This is conceptually illustrated in FIG. 1G. The options wheel 130 defines a cyclic arrangement of options, such that rotation of the options in a given direction will result in cycling through each of the available options in a predefined order, eventually returning to the initial starting position.

In the illustrated embodiment, the options wheel 130 includes options 134, 136, 138, 140, 142, 144, 146, 148, 150, and 152. Options 134, 136, 138, 140, and 152, are presently displayed, at least in part, on the touchscreen display 100. The options 142 through 150 are implied off-screen, and may be rotated onto the touchscreen display in accordance with their predefined cyclic ordering.

The conceptual construct of a wheel or cyclic arrangement of options provides advantages over a traditional list of options. For example, with a traditional list of options, it is difficult to rearrange options without causing confusion for the user, who may have come to expect specific options to be situated at specific locations within the list. However, a cyclic arrangement or a wheel of options can be rotated to a specific option without causing confusion regarding the overall arrangement of options. This allows for dynamic configuration of the cyclic arrangement so that it is rotated to a predicted option, without requiring rearrangement of the ordering of the options.

The available options can define actions related to a given object. A given object can have any number of contextually appropriate options/actions provided therefore, including, without limitation, the following: share, save, call, message, copy, paste, send (e.g. to a directory destination such as a folder, to a friend/contact, to a device, or other recipients), designate as a favorite, bookmark, tag, indicate approval (e.g. endorse, like, thumbs up, etc.), delete, apply a function, etc. Additionally, a given option may provide access to additional sub-menus.

The configuration of options presented to the user can be defined in a predictive manner, such that the selection of options, their arrangement/ordering, and/or the default rotation position of the cyclic arrangement is defined to present the user with options that the user is determined to be likely to choose. Factors which may be considered include, without limitation, attributes/features/categorizations of the selected object, a user's interaction history with objects having similar attributes, the time of day, a user's profile, a user's indicated preferences or settings, etc. For purposes of illustration, some examples are considered below.

In some embodiments, a system may determine based on the user's prior history of sharing content, that the user tends to share certain types of content with certain users. For example, the user may tend to share sports articles with a certain set of users, but tend to share finance articles with a different set of users. This information can be leveraged to define the options that are presented when the user selects a given content object. For example, if the user selects a sports article, then the options can be configured so that the users with whom the sports article is likely to be shared are more easily accessible. The options may be defined and/or arranged so that such users are included and prioritized. Also, the cyclic arrangement may be presented at a default rotational position wherein one or more of such users are visible on-screen as options.

In some implementations, the cyclic arrangement may be defined to identify as options, members of a user's contacts list, or a subset thereof. In response to selection of a given content type, the cyclic arrangement is presented at a default rotational position so that a user with whom the selected content is likely to be shared will be presented as an option on-screen.

The concepts can be extended to include other destinations or actions, such as social networks, communication methods, applications, etc. For example, it may be determined that the user tends to share sports articles to a social network, whereas the user tends to e-mail finance articles. If the user selects a sports article, then the options wheel can be configured to include the social network as an option, and the options wheel can also be presented in a default rotational orientation so that the social network option is presented as the nearest available option. Whereas if the user selects a finance article, then the options wheel would be configured to include e-mail as an option, and the options wheel would be presented in a default rotational orientation so that the e-mail option is presented as the nearest available option.

It will be appreciated that any type of relevant information can be analyzed to identify predicted actions for a given user and a given content object. Such information need not be specifically associated with the content object or the mode of taking action with respect to the content object presently described. For example, it may be determined from a user's e-mail history that the user tends to discuss sports-related topics with certain users. The presentation of options when a sports article is selected can therefore be configured to include and prioritize such users.

Though in the foregoing, the specific examples of sports articles and finance articles have been employed, it will be appreciated that these are discussed by way of example only. The concepts described herein can be applied to any other types of content without limitation, to provide for prediction of actions/options which a user is likely to take for a given content object.

It will be appreciated that selection of a given option/action will result in various activities depending upon the specific option/action that is invoked. For example selection of an option to share a content item to a social network may effect display of an interface for generating a post to the social network. The interface may be preconfigured to include a reference to the content item. Furthermore, a separate application for the social network may be invoked.

In another example, selection of a specific contact/user may effect display of options for communicating with the selected contact/user, such as e-mail, text message, chat, private message, MMS, etc. Subsequent selection of one of these communication options may open up a respective interface for generating and sending the communication.

In a related example, selection of an option to e-mail a content item may open up an interface for generating the e-mail. A separate e-mail application may be invoked to generate the e-mail. A similar communication paradigm can be configured for any other type of communication form.

FIGS. 2 through 7 illustrate additional examples of interfaces which may provide options for a selected object. The selected object can be selected through a tap and hold interaction, providing control over the movement of the object, as discussed above.

FIG. 2 illustrates an embodiment wherein in response to selection of the object 200 by the user, two options exposed from top and bottom portions of the display, in accordance with an embodiment of the invention. An option 202 is exposed from the top portion of the display, whereas an option 204 is exposed from the bottom of the display. Each of the options defines a region to indicate selection of the option. When the object 200 is dragged towards, over, or into the region defined by the option 202 or 204, then the option can be indicated as being active, and upon release of the object 200 by the user (i.e. user stops touching the touchscreen display, thereby releasing the object), then the active option is selected. In the illustrated embodiment, the options 202 and 204 are illustrated as having substantially semicircular forms. However, in other implementations, the options can have any shape or form which defines a spatial region on the display.

FIG. 3 illustrates an interface wherein options are arranged surrounding a selected object 300, in accordance with an embodiment of the invention. In the illustrated embodiment, options 302, 304, 306, 308, 310, and 312 are arranged in a circular formation surrounding the selected object 300. The user may drag the object 300 towards or onto a given one of the options, and release the object 300 to select the one of the options.

FIG. 4 illustrates an interface wherein options are arranged along a side of the display, in accordance with an embodiment of the invention. In the illustrated embodiment, options 402 through 416 are arranged as a scrollable vertical list along a right side of the display. However, it will be appreciated that the options may be displayed along any side of the display. The list may be scrolled in response to movement of the object 400 up or down. Furthermore, the object 400 may be transformed upon selection so as to define a pointer directed towards the side of the display on which the options are presented. The pointer can be directed by the user towards a given option so as to indicate activation or selection of the given option.

FIG. 5 illustrates an interface having two options wheels displayed at top and bottom portions of the display, in accordance with an embodiment of the invention. In response to selection of an object 500, options wheels 502 and 514 are exposed at top and bottom portions of the display, respectively. The options wheels 502 and 514 can each define a category of options which are arranged in a cyclic ring. The options wheel 502 includes options 504 through 512, whereas the options wheel 514 includes options 516 to 524. Each of the options wheels may spin in response to movement of the object 500 by the user, and a given option can be selected by dragging the object 500 towards or over the given option and releasing the object 500.

In some implementations, the options wheels can be organized so that options relating to sharing or sending of the object to others are provided at the top portion of the display (e.g. share to social network, send to specific contact, etc.), whereas options relating to the user's account or the user's device alone are provided at the bottom portion of the display (e.g. save, bookmark, copy, etc.).

FIG. 6 illustrates an interface wherein a selected object is surrounded by a plurality of options, in accordance with an embodiment of the invention. In the illustrated embodiment, the selected object 600 is anchored to a central location and surrounded by options 602 to 616. The object 600 is moveable to a limited extent in a direction away from the central location, and the direction of the movement of the object 600 designates a given option for selection upon release of the object 600. The object 600 thus functions in a manner similar to that of a joystick. In the illustrated embodiment, the options are arranged in a pie-shaped configuration, though in other implementations, other shapes or configurations can be utilized. As shown, the object 600 is moved towards the option 602, which is thereby highlighted to indicate its designation for selection. If the user releases the object 600 by releasing their finger from the touchscreen, then the option 602 will be selected and invoked.

FIG. 7 illustrates an interface wherein two horizontal scrollable lists are rendered along top and bottom portions of the display, in accordance with an embodiment of the invention. A top list is defined to include options 702 to 710, and a bottom list is defined to include options 712 to 720. Additional options can be revealed from a list by scrolling the list to the right or left, which may be accomplished by moving the object 700 towards the right or left side of the list. In the illustrated embodiment, the object 700 has been transformed to define a pointer, which can be directed towards one of the options. As the object 700 has been moved towards the top list and is pointed towards the option 706, the option 706 is expanded in appearance, indicating its designation for selection if the object 700 is released.

FIGS. 8A, 8B, and 8C illustrate a transformation sequence for an object that has been selected, in accordance with an embodiment of the invention. At FIG. 8A, the object 800 is shown in its initial state, including a text portion 804 and a media portion 802 (e.g. an image or video). Upon selection of the object 800 (e.g. by tap-and-hold), the object 800 is transformed according to the illustrated sequence so as to indicate selection of the object 800 as well as provide for a more intuitive control over the object 800. At FIG. 8B, the text portion 804 of the object 800 has been faded and reduced in size. Also, the relative dimensions of the object 800 have changed such that the width of the object 800 is reduced. Simultaneously, the height of the media portion 802 is increased to occupy a greater proportion of the object 800. At FIG. 8C, the transformation is complete, with the text portion no longer displayed, and the media portion 802 being vertically stretched to occupy the major portion of the object 800. The media portion 802 may also be cropped during the transformation process.

In some embodiments, the transformation of an object includes detection of its elements, so that certain elements may be prioritized over other elements, in the transformed version of the object. For example, images may be prioritized over text, as in the above-described sequence. Furthermore, image recognition may be employed to identify an object of significance in an image. The image may be cropped to the identified object, so that it is visible in the final transformed object. For example, image recognition may identify a person, a person's face, an animal, a building, a vehicle, etc., and such may be preserved during the transformation process so that it is visible in the completed transformed object.

FIGS. 9A, 9B, and 9C illustrate a transformation sequence for a selected object 900, in accordance with an embodiment of the invention. At FIG. 9A, the object 900 is shown in its initial state. As illustrated at FIG. 9B, the top portion 906 as well as a corner portion 904 are animated so as to appear to be folded back. When the folding animation is complete, the portion 902 of the object remains in view, forming a point on the right side, which as discussed above, can be utilized as a pointer to designate various options.

FIGS. 10A, 10B, and 10C illustrate a transformation sequence for a selected object 1000, in accordance with an embodiment of the invention. At FIG. 10A, the object 1000 is shown in its initial state, including an element 1002, and an element 1004. At FIG. 10B, the element 1004 as well as the border of the object 1000 is faded from view. At FIG. 10C, the transformation is complete, with all elements except for the element 1002 being faded from view.

FIGS. 11A, 11B, and 11C illustrate a transformation sequence for a selected object 1100, in accordance with an embodiment of the invention. At FIG. 11A, the object 1100 is shown in its initial state. At FIG. 11B, in response to the user touching and holding the object 1100, a transparency mask effect is applied to the object 1100, so that the object 1100 appears desaturated or faded except for a region 1102 surrounding the location being touched by the user. At FIG. 11C, the region 1102 is reduced in size.

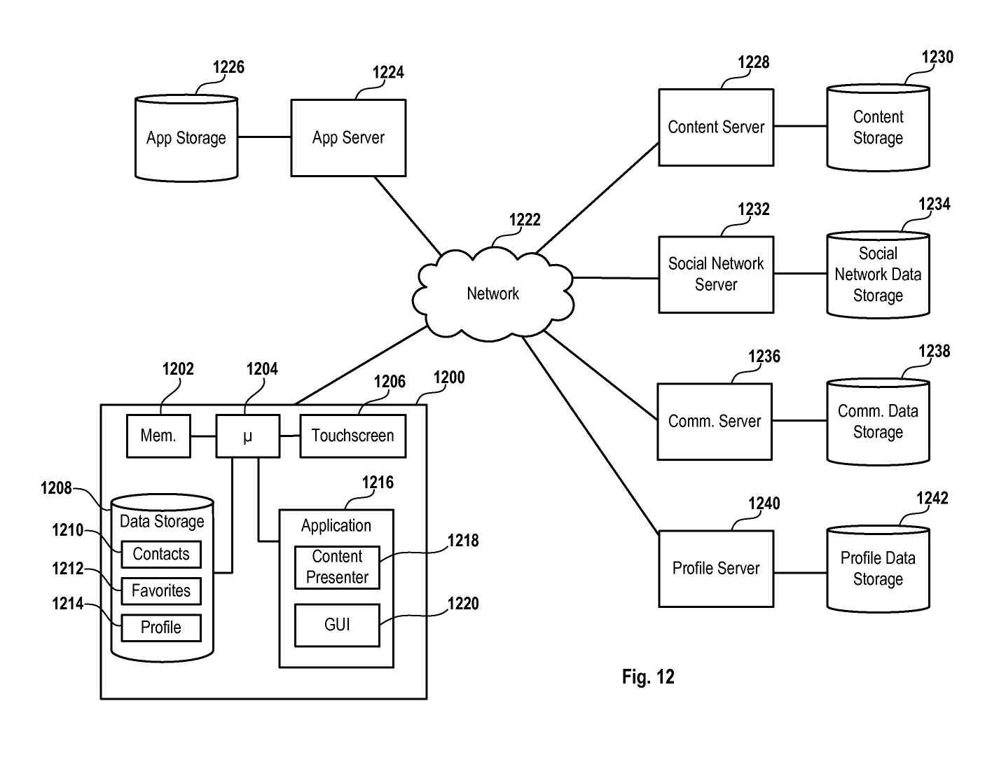

FIG. 12 illustrates a system for presentation and sharing of content, in accordance with an embodiment of the invention. A user device 1200 is defined to include memory 1202 for storing program instructions for execution, at least one processor 1204 for executing program instructions, and a touchscreen display 1206. A data storage 1208 is included for storing data. The data storage 1208 of the user device 1200 can include a user's contacts 1210, favorite content items 1212, and a user profile 1214.

The user device 1200 is configured to execute an application 1216, having a content presenter 1218 that is configured to retrieve and present content from a content server 1228 (that retrieves content from a content storage 1230), and a GUI 1220 that presents options in response to selection of a content object, as discussed elsewhere herein. The user device 1200 is capable of communicating over a network 1222, which can include any of various types of networks facilitating communication of data.

The application 1216 can be a standalone application executed in the native operating system environment of the user device 1200. The application 1216 can be downloaded from an application server 1224 that retrieves the application from an application storage 1226. In some implementations, the application 1216 is a web browser. In some implementations, the application 1216 is instantiated in a sub-context of another application, such as a browser application.

A social network server 1232 provides access to a social network, and is connected to a social network data storage 1234, containing data for defining the social network.

A communications server 1236 provides a communication service, such as e-mail, chat, private messaging, text messaging, and/or other forms of electronic communication. A communication data storage 1238 is provided for storage of communications data.

A profile server 1240 is provided for determining a profile for a given user. The profile can define various content preferences of the user, historical activity patterns, interests, etc. User profiles are stored to a profile data storage 1242.

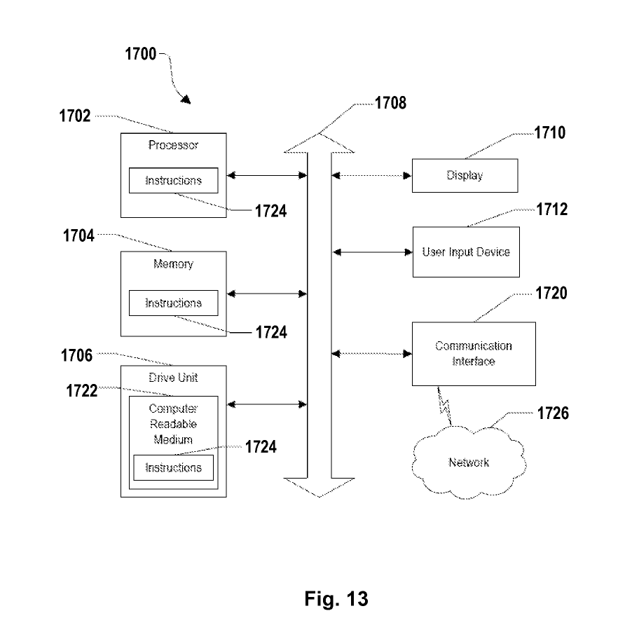

FIG. 13 illustrates an embodiment of a general computer system designated 1700. The computer system 1700 can include a set of instructions that can be executed to cause the computer system 1700 to perform any one or more of the methods or computer based functions disclosed herein. The computer system 1700 may operate as a standalone device or may be connected, e.g., using a network, to other computer systems or peripheral devices.

In a networked deployment, the computer system 1700 may operate in the capacity of a server or as a client user computer in a server-client user network environment, or as a peer computer system in a peer-to-peer (or distributed) network environment. The computer system 1700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1700 can be implemented using electronic devices that provide voice, video or data communication. Further, while a single computer system 1700 is illustrated, the term “system” shall also be taken to include any collection of systems or sub-systems that individually or jointly execute a set, or multiple sets, of instructions to perform one or more computer functions.

As illustrated in FIG. 13, the computer system 1700 may include a processor 1702, e.g., a central processing unit (CPU), a graphics processing unit (GPU), or both. The processor 1702 may be a component in a variety of systems. For example, the processor 1702 may be part of a standard personal computer or a workstation. The processor 1702 may be one or more general processors, digital signal processors, application specific integrated circuits, field programmable gate arrays, servers, networks, digital circuits, analog circuits, combinations thereof, or other now known or later developed devices for analyzing and processing data. The processor 1702 may implement a software program, such as code generated manually (i.e., programmed).

The computer system 1700 may include a memory 1704 that can communicate via a bus 1708. The memory 1704 may be a main memory, a static memory, or a dynamic memory. The memory 1704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1704 includes a cache or random access memory for the processor 1702. In alternative embodiments, the memory 1704 is separate from the processor 1702, such as a cache memory of a processor, the system memory, or other memory. The memory 1704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1704 is operable to store instructions executable by the processor 1702. The functions, acts or tasks illustrated in the figures or described herein may be performed by the programmed processor 1702 executing the instructions stored in the memory 1704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1700 may further include a display unit 1710, such as a liquid crystal display (LCD), an organic light emitting diode (OLED), a flat panel display, a solid state display, a cathode ray tube (CRT), a projector, a printer or other now known or later developed display device for outputting determined information. The display 1710 may act as an interface for the user to see the functioning of the processor 1702, or specifically as an interface with the software stored in the memory 1704 or in the drive unit 1706.

Additionally or alternatively, the computer system 1700 may include an input device 1712 configured to allow a user to interact with any of the components of system 1700. The input device 1712 may be a number pad, a keyboard, or a cursor control device, such as a mouse, or a joystick, touch screen display, remote control or any other device operative to interact with the computer system 1700.

The computer system 1700 may also or alternatively include a disk or optical drive unit 1706. The disk drive unit 1706 may include a computer-readable medium 1722 in which one or more sets of instructions 1724, e.g. software, can be embedded. Further, the instructions 1724 may embody one or more of the methods or logic as described herein. The instructions 1724 may reside completely or partially within the memory 1704 and/or within the processor 1702 during execution by the computer system 1700. The memory 1704 and the processor 1702 also may include computer-readable media as discussed above.

In some systems, a computer-readable medium 1722 includes instructions 1724 or receives and executes instructions 1724 responsive to a propagated signal so that a device connected to a network 1726 can communicate voice, video, audio, images or any other data over the network 1726. Further, the instructions 1724 may be transmitted or received over the network 1726 via a communication port or interface 1720, and/or using a bus 1708. The communication port or interface 1720 may be a part of the processor 1702 or may be a separate component. The communication port 1720 may be created in software or may be a physical connection in hardware. The communication port 1720 may be configured to connect with a network 1726, external media, the display 1710, or any other components in system 1700, or combinations thereof. The connection with the network 1726 may be a physical connection, such as a wired Ethernet connection or may be established wirelessly as discussed below. Likewise, the additional connections with other components of the system 1700 may be physical connections or may be established wirelessly. The network 1726 may alternatively be directly connected to the bus 1708.

While the computer-readable medium 1722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed herein. The computer-readable medium 1722 may be non-transitory, and may be tangible.

The computer-readable medium 1722 can include a solid-state memory such as a memory card or other package that houses one or more non-volatile read-only memories. The computer-readable medium 1722 can be a random access memory or other volatile re-writable memory. Additionally or alternatively, the computer-readable medium 1722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1700 may be connected to one or more networks 1726. The network 1726 may define one or more networks including wired or wireless networks. The wireless network may be a cellular telephone network, an 802.11, 802.16, 802.20, or WiMax network. Further, such networks may include a public network, such as the Internet, a private network, such as an intranet, or combinations thereof, and may utilize a variety of networking protocols now available or later developed including, but not limited to TCP/IP based networking protocols. The network 1726 may include wide area networks (WAN), such as the Internet, local area networks (LAN), campus area networks, metropolitan area networks, a direct connection such as through a Universal Serial Bus (USB) port, or any other networks that may allow for data communication. The network 1726 may be configured to couple one computing device to another computing device to enable communication of data between the devices. The network 1726 may generally be enabled to employ any form of machine-readable media for communicating information from one device to another. The network 1726 may include communication methods by which information may travel between computing devices. The network 1726 may be divided into sub-networks. The sub-networks may allow access to all of the other components connected thereto or the sub-networks may restrict access between the components. The network 1726 may be regarded as a public or private network connection and may include, for example, a virtual private network or an encryption or other security mechanism employed over the public Internet, or the like.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for determining an action to be performed for a content item, comprising:
presenting a content item on a touch screen;
receiving input via the touch screen indicating selection of the content item, wherein the selection of the content item produces a reduced version of the content item;
in response to receiving the input, displaying a plurality of options on the touch screen, each of the options identifying an action to be taken for the content item;
detecting a dragging action on the reduced version of the selected content item that places the reduced version of the content item proximate to one of the plurality of options to indicate selection of the one of the plurality of options;
performing the action identified by the selected one of the options for the content item;
the method being executed by a processor.

2. The method of claim 1, wherein each option is rendered as a graphical icon or textual identifier on the touch screen.

3. The method of claim 1, wherein the placement of the reduced version of the content item proximate to the one of the plurality of options is defined by placement of the reduced version adjacent to, partially overlapping, or fully overlapping, the one of the plurality of options.

4. The method of claim 1, wherein the plurality of options that are displayed define a portion of a cyclic arrangement of options.

5. The method of claim 1, wherein the plurality of options include one or more of a social network, an electronic communication, a contact.

6. The method of claim 1, wherein producing the reduced version of the content item includes identifying an image in the content item, and prioritizing the image in the reduced version of the content item.

7. The method of claim 1, wherein the input indicating selection of the content item is defined by a tap gesture or a tap-and-hold gesture.

8. A method for determining an action to be performed for a content item, comprising:
presenting a content item on a touch screen;
receiving a first input via the touch screen, the first input indicating selection of the content item;
in response to receiving the first input, rendering a portion of a cyclic arrangement of options on the touch screen, each of the options identifying an action to be taken for the content item;
receiving a second input via the touch screen, the second input indicating a selected option of the cyclic arrangement;
in response to receiving the second input, performing the action identified by the selected one of the options for the content item;
the method being executed by a processor.

9. The method of claim 8,
wherein the first input is defined by a tap-and-hold gesture received via the touch screen and applied to the content item, the tap-and-hold gesture indicating selection of the content item and providing for control over movement of the content item as it is rendered on the touch screen;
wherein the second input is defined by a drag-and-release gesture received via the touch screen and applied to the content item, the drag-and-release gesture providing for movement of the content item to the selected option and placement thereon.

10. The method of claim 8, wherein the cyclic arrangement identifies options for sharing the content item to one or more of a social network, a specific user.

11. The method of claim 10, wherein selection of the option to share to a social network provides access to an interface for generating a post to the social network, the post being predefined to include a reference to the content item.

12. The method of claim 8,
wherein the cyclic arrangement is configured for rotation in response to a third input;
wherein rotation exposes an additional option, and hides an existing option, in the rendered portion of the cyclic arrangement.

13. The method of claim 8, further comprising:
determining a rotational position of the cyclic arrangement of options, the rotational position defining the portion of the cyclic arrangement that is rendered, wherein the rotational position is determined based on one or more of an attribute of the content item, a profile of a user of the touch screen, a communications history associated to the user.

14. A non-transitory computer-readable medium having program instructions defined thereon for determining an action to be performed for a content item, the program instructions including:
program instructions for presenting a content item on a touch screen;
program instructions for receiving input via the touch screen indicating selection of the content item, wherein the selection of the content item produces a reduced version of the content item;
program instructions for, in response to receiving the input, displaying a plurality of options on the touch screen, each of the options identifying an action to be taken for the content item;
program instructions for detecting a dragging action on the reduced version of the selected content item that places the reduced version of the content item proximate to one of the plurality of options to indicate selection of the one of the plurality of options;
program instructions for performing the action identified by the selected one of the options for the content item.

15. The non-transitory computer-readable medium of claim 14, wherein each option is rendered as a graphical icon or textual identifier on the touch screen.

16. The non-transitory computer-readable medium of claim 14, wherein the placement of the reduced version of the content item proximate to the one of the plurality of options is defined by placement of the reduced version adjacent to, partially overlapping, or fully overlapping, the one of the plurality of options.

17. The non-transitory computer-readable medium of claim 14, wherein the plurality of options that are displayed define a portion of a cyclic arrangement of options.

18. The non-transitory computer-readable medium of claim 14, wherein the plurality of options include one or more of a social network, an electronic communication, a contact.

19. The non-transitory computer-readable medium of claim 14, wherein producing the reduced version of the content item includes identifying an image in the content item, and prioritizing the image in the reduced version of the content item.

20. The non-transitory computer-readable medium of claim 14, wherein the input indicating selection of the content item is defined by a tap gesture or a tap-and-hold gesture.
